(19) United States
(12) Patent Application Publication
(10) Pub. No.: US 2012/0209680 A1
(43) Pub. Date: Aug. 16, 2012

(54) METHOD, PROGRAM AND SYSTEM FOR PROMOTING CHAIN TRANSACTIONS

(76) Inventor: Po-Kai CHAN, Keelung City (TW)

(21) Appl. No.: 13/371,515

(22) Filed: Feb. 13, 2012

(30) Foreign Application Priority Data
Feb. 15, 2011 (TW) 100104934

(51) Int. Cl. G06Q 30/02; G06Q 30/06

(52) U.S. Cl. 705/14.23; 705/26.1; 705/27.1

(57) ABSTRACT

Disclosed are a method, a computer executable program and a system for promoting chain transactions. The method, program and system serve to distribute sales margin to related consumers and to automatically generate and disseminate the consumers' personalized comments upon completion of the transactions. The integrated purchase, comment and dissemination as a whole conveniently promotes chain transactions and encourage more consumers' induced consumption, thereby significantly saving marketing costs.

### BACKGROUND OF THE INVENTION

1. Technical Field

The present invention relates to a method, a computer-executable program and a system for promoting chain transactions.

2. Description of Related Art

The internet is now an important medium of information dissemination, data transaction and commercial activities, and has inspired various modes of the so-called E-commerce. When one wants to buy things by spending less, he/she may perform search in online auction sites or shopping sites, or he/she can seek over the web for a group-buying offer related to merchandise he/she is interested in. Group-buying allows a group of consumers to purchase together with discounted prices, so information dissemination before and/or after purchase is critical to assemble more people to join the group and make the discount offered or maintained.

Traditionally, such information dissemination is made by the vendors through commercials and marketing activities, so more transactions done means more money and energy have been spent for advertising. Some vendors thus try to reward certain consumers who initiate group-buying activities. However, this existing approach using certain consumers as hubs is quite narrow with respect to the vast web-based market and is confined to the thinking of vendors but not consumers.

### SUMMARY OF THE INVENTION

In the conventional consumer-rewarding scheme, a consumer has to perform purchase and dissemination separately and the reward given thereto is immediately related to how many transactions the consumer directly causes. The existing approach is thus not popular because no consumer likes to take additional time and energy to peddle like a salesperson just for the small rewards.

In view of this, for improving the exiting consumer-rewarding scheme, it is necessary to find ways to save the time required by performing dissemination and to reward consumers more relevantly.

Therefore, the present invention provides a method, a computer executable program and a system for promoting chain transactions, wherein a transaction and corresponding dissemination can be accomplished almost simultaneously and a coadjutant consumption environment can be created to nurture social-shopping behavior.

In some of various embodiments of the present invention, the method for prompting chain transactions comprises receiving a merchandise information about a commodity from a database, and defining a part of a profit generated in a transaction of the commodity as a reward for a consumer who makes the transaction and performs dissemination of the transaction, whereby an incentive mechanism is built for promoting more sequent transactions, wherein completion of each said transaction results in generation of a unique transaction serial number and a corresponding transaction page that jointly function as a node for determining the reward and for recognizing the dissemination, in which the transaction page is associated with at least one social network where the dissemination is performed., thereby realizing the coadjutant consumption environment.

In some of various embodiments of the present invention, the incentive mechanism allows setting parameters including different amounts of the rewards for the nodes of different tiers, a number of the tiers backward traceable to be rewarded, a proportion of the reward with respect to the profit, and a limited number of said sequent transactions allowable to be made rewarded through each said transaction serial number or each said node, in which each combination of the parameters of different settings is defined as a rewarding model.

In some of various embodiments of the present invention, the transaction page is associated with said social network by adopting an API (Application Programming Interface) of a medium of the social network so as to share information with the social network.

In some of various embodiments of the present invention, the transaction page is associated with said social network by making a webpage of the social network assessable from the transaction page through a plug-in program, an RSS reader, an Atom reader or an XML protocol application.

In some of various embodiments of the present invention, the transaction page is associated with said social network by making an instant messenger related to said social network assessable from the transaction page through a plug-in program, an RSS reader, an Atom reader or an XML protocol application.

In some of various embodiments of the present invention, the transaction page is associated with said social network by accessing information from the social network through a plurality of programs that allow the information to be loaded in a smart phone, an e-book reader or a mobile electronic device.

In some of various embodiments of the present invention, only a limited number of said sequent transactions are allowed to be made through each said transaction serial number or each said node, so that when the number is reached, the incentive mechanism uses another said transaction serial number or another said node to complete further sequent transactions.

In some of various embodiments of the present invention, the computer executable program for facilitating dissemination serves to: when a transaction button is triggered by a consumer to complete a transaction of a commodity, automatically compare a merchandise information of the commodity to recommendation comment keywords, personal comment keywords set by the consumer and past comment records, and accordingly generate options of recommended comments about the commodity for the consumer to adopt, so that the consumer is allowed to use any of the automatically generated recommended comments or revise any of the automatically generated recommended comments before use, and upon the consumer's decision of the comment(s), the merchandise information, the merchandise information, a transaction and the comment(s) are automatically posted on an associated website or sent to a preset group of audience, thereby facilitating dissemination.

In some of various embodiments of the present invention, the computer executable program further serves to facilitate chain dissemination by allowing the audience interested in the dissemination to click on a response button for generating a personalized comment about the commodity.

In some of various embodiments of the present invention, the computer executable program further serves to promote chain greeting in a social network by allowing the audience to click on a greeting button for generating a personalized greeting message.

In some of various embodiments of the present invention, the computer executable program further serves to facilitate assembly of members of a social network and in turn facilitate chain response by allowing the audience to click on a reply button related to a certain activity for generating a personalized comment about the activity.

In some of various embodiments of the present invention, the comment has a format selected from the group consisting of a user diary, a user feedback, an open-box report, a blog post, an experience sharing, a user reference and any combination thereof.

In some of various embodiments of the present invention, the past comment records is extracted from comment keyword database where the past comments of all the consumers and about all the commodities are collected and classified according to consumer groups, merchandise groups and frequencies of use.

In some of various embodiments of the present invention, the system for prompting chain transactions comprises: a server for storing the system and a database for storing data about commodities, merchandise details, rewarding models, an incentive mechanism, consumers, transactions, dissemination targets, rewarding information and rewarding records, whereby upon completion of a transaction where a transaction page is generated by the incentive mechanism, when a consumer triggers a transaction button on the transaction page, an automatic personalized-comment generating mechanism is actuated so that the system disseminates the consumer's comment(s) together with information abstracted from the transaction page to the dissemination targets.

In some of various embodiments of the present invention, the server is realized by a system incorporating SaaS (Software as a Service), PaaS (Platform as a Service) and/or other cloud-based technologies.

In some of various embodiments of the present invention the transaction page is provided as a webpage of a social network, in which each said consumer is allotted with an exclusive webpage where records of the consumer's transactions are provided.

In some of various embodiments of the present invention, the transaction page appears in a webpage of a social network as a function module by adopting an API (Application Programming Interface) of a medium of the social network.

In some of various embodiments of the present invention, the system further includes a credit rating mechanism, wherein the consumers who perform transactions as parties following each other are rewarded with points in their respective credit ratings, and cancellation of any said transaction results in taking the rewarded points off.

In some of various embodiments of the present invention, the dissemination targets include a personal mobile device that accesses digital contents issued by the system through a preloaded application.

In some of various embodiments of the present invention, the chain transactions includes transactions of physical merchandise, virtual merchandise, virtual currency, digital contents, services, commercial donation and/or non-commercial donation.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic diagram of an exemplary structure for realizing the present invention;

FIG. 2 illustrates how the present invention promotes chain transactions;

FIG. 3 shows rewarding models set in the rewarding-model selecting unit for selectively use;

FIG. 4 illustrates how an intellective comment managing unit works for information forwarding and controlling; and

FIG. 5 illustrates how a user access data through different media by using the method and system of the present invention.

### DETAILED DESCRIPTION OF THE INVENTION

While the present invention particularly proposes a method, a computer executable program and a system for promoting chain transactions, it is to be noted that the present invention is realizable in other means, such as a process, a device, a computer, a readable medium and more. Although some preferred embodiments are shown in the accompanying drawings and will be described in detail for illustrating the present invention, they are not intended to form limitation to the present invention.

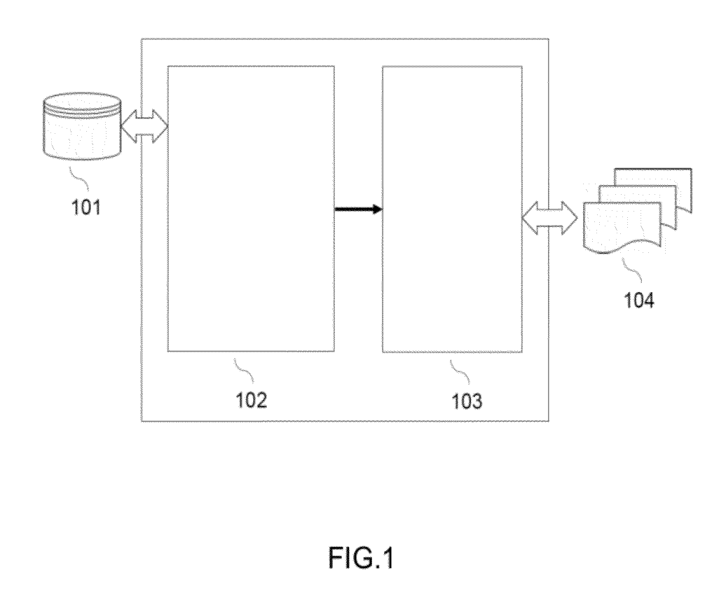

FIG. 1 is a schematic diagram of an exemplary structure for realizing the present invention. In the present embodiment, the method includes receiving merchandise information about a commodity from an E-commerce database 101 and defining a part of a profit generated in a transaction of the commodity as a reward for a consumer who makes the transaction and performs dissemination of the transaction. The mechanism such built is herein referred to as an incentive unit 102. The incentive unit 102 works with a transaction-information forwarding unit 103 that integrates functions of performing transactions, automatically providing personalized comments and automatic dissemination, and a transaction page 104 serving to publish information, accept transactions and share the comments.

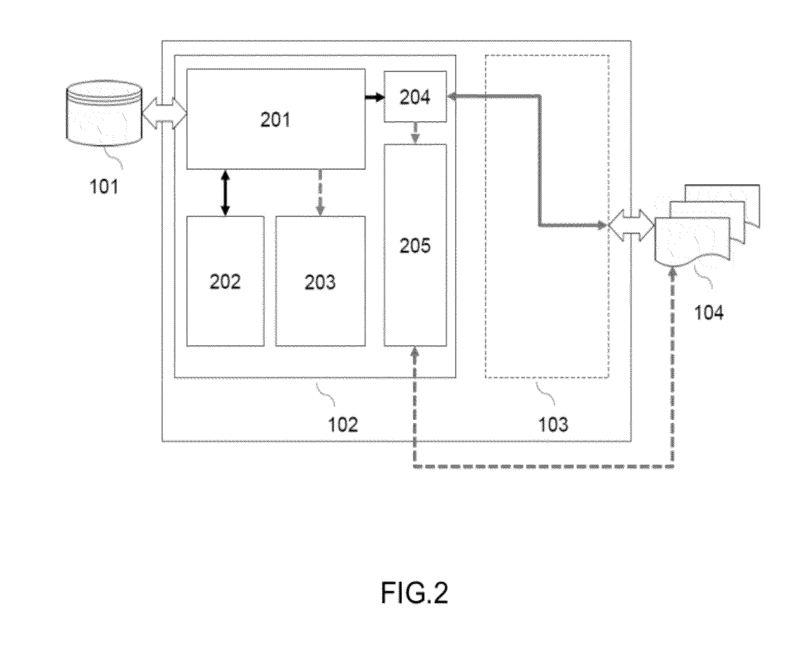

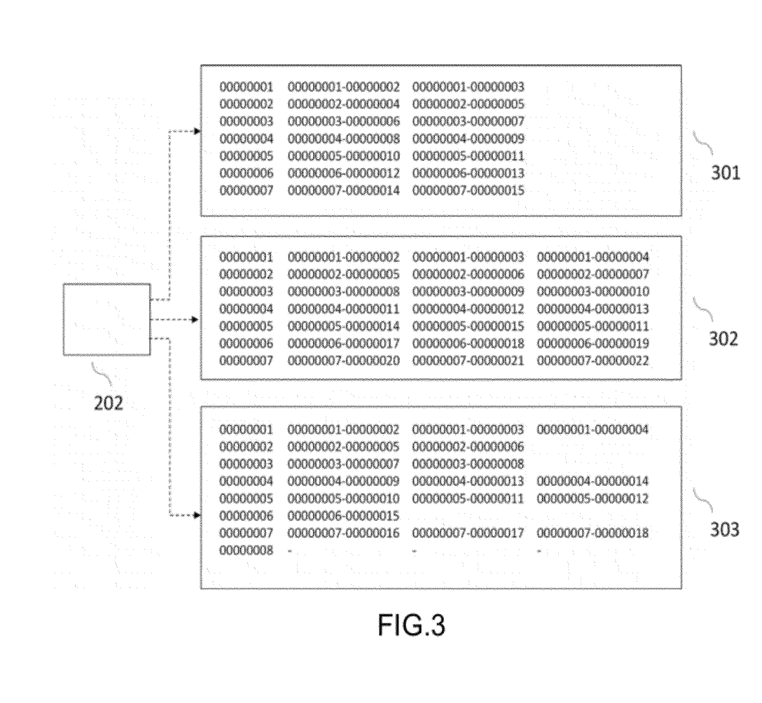

FIG. 2 illustrates how the present invention promotes chain transactions. As shown, a merchandise information managing unit 201 converts the information about the commodity into an incentive information related to the reward and provides recommended comment keywords related to the commodity for intellective comment composition. After the merchandise information is converted, a rewarding-model selecting unit 202 adopts a preset setting of rewarding parameters or defines parameters on its own, so as to generate relevant reward distribution. On the other hand, a reward managing unit 203 activates calculation and payment of the reward according to the profit generated. Then a transaction managing unit 204 takes over the transaction and assigns an exclusive transaction serial number for each transaction. The transaction managing unit 204 also generates an exclusive transaction page, namely the transaction page 104, and an identification code for each transaction. The identification code including information about the commodity, the consumer and the transaction serial number is then delivered to a track managing unit 205. Herein, suitable flow management techniques may be used so that after the chain transactions are made, reports can be generated a website in terms of transaction relations, sequent transactions (or following transactions), comments made, dissemination effects, message hits, and how a certain transaction is followed, so as to remind the consumer making the original transaction to take interactive actions for the website. When a chain is initiated by one consumer performing an original transaction and other consumers performing sequent transactions through the transaction page of the original transaction, tiers of transaction pages/nodes are formed. For the purpose of this invention, a transaction in a lower tier is referred to as a sequent/following transaction of a transaction in a higher tier. The consumer performing the transaction in the higher tier (at the node in the higher tier) is rewarded with a certain proportion of the profit generated in the sequent transaction. The present invention allows setting different parameters, such as the amounts (or proportions) of the rewards for the nodes of different tiers, a number of the tiers backward traceable to be rewarded, a proportion of the reward with respect to the profit, and a limited number of said sequent transactions allowable to be made rewarded through each said transaction serial number or each said node. Each combination of the parameters of different settings is defined as a rewarding model, so that several rewarding models may be preset for easy adoption. For example, as shown in FIG. 3, rewarding models 301, 302 and 303 are set in the rewarding-model selecting unit 202 for selectively use. In one embodiment, only a limited number of said sequent transactions are allowed to be made through each said transaction page /node, so that when the number is reached at one node, consumer intending to make further sequent transactions will be guided to another transaction page /node currently “followable”. Thereby, the present invention promotes chain transactions and encourages interaction as well as mutual trust between consumers. For preventing excessive dissemination that cause “info pollution” to the irrelevant audience, consumers may optionally join one or more social groups or communities. In this case, the inventive system may further include a credit rating mechanism, wherein the consumers who perform transactions as parties following each other are rewarded with points in their respective credit ratings, and cancellation of any said transaction results in taking the rewarded points off. The credit rating mechanism thus allows consumers to build their personal credits in the groups/communities they join and thereby attract more consumers to follow their transactions, in turn promoting sequent, chain transactions.

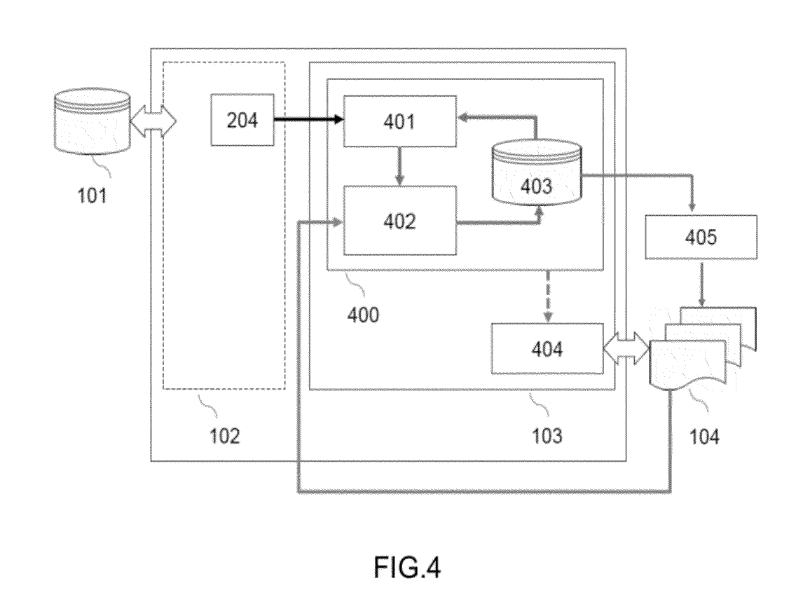

In addition to discounts incurred by group-buying behaviors, one ignorable component of promotion is consumers' comments on, recommendation for or reference to commodities. However, it has been difficult to have consumers actively make comments and/or dissemination for the commodities they buy because, as mentioned above, this takes additional energy and time in the existing approach. The present invention thus solves this plight by, to the largest possible extent, maintaining consumers' operational habit and simplifying the process of making comment as well as dissemination. Therefore, in one embodiment of the present invention, the computer executable program for facilitating dissemination that prompts chain transactions is realized by making the best of the automatic and intellective functions of a computer. In this embodiment, consumer can make purchase, comment and dissemination in an integrated operational process, which is referred to as “Easy Push” herein. Particularly, when a transaction button is triggered by a consumer to complete a transaction of a commodity, the computer executable program automatically generates personalized comments and automatically posts the comments on an a preset webpage or sends the comments to a carrier or device that can read the comments, thereby accomplishing easy, convenient and meaningful dissemination. FIG. 4 illustrates an intellective comment managing unit 400 for this purpose. According to this embodiment, when the transaction button is triggered, the transaction managing unit 204 synchronously activates an automatic comment generator 401 that serves to compare a merchandise information of the commodity to recommendation comment keywords, personal comment keywords set by the consumer and past comment records stores in a comment managing module 402, so as to sort these data in terms of classification and the consumer's personal preference, thereby generating combinations of these data as options to be stored in a comment keyword database 403. Then the automatic comment generator 401 can automatically provide a predetermined set of personalized comments according to the classification or attribution of the commodity. At this time, the consumer can easily make his/her comments by confirming any or all of the options so provided. Alternatively, the consumer may make another combination of these or other comments or may draft a new comment. At last, the comments finalized so are submitted to a dissemination managing unit 404 for the latter to forward to various media. The integrated operational process of transaction, comment and dissemination is thereby accomplished. This ensures more relevant comments and more effective dissemination. Moreover, for further improving the integrated operational process by making these data more retrievable, an intellective comment retrieving unit 405 may be connected to the comment keyword database 403. The intellective comment retrieving unit 405 statistically analyzes the comments from individual consumers, the comments for different types of transactions and the comments about individual commodities, and summarizes the comments from all consumers, so as to generate a search guide, a consumer guide, a purchase recommendation, a user reference search, a list of best sold items, a list of hot comment keywords and so on, thereby further promoting commodities in a user-specific fashion.

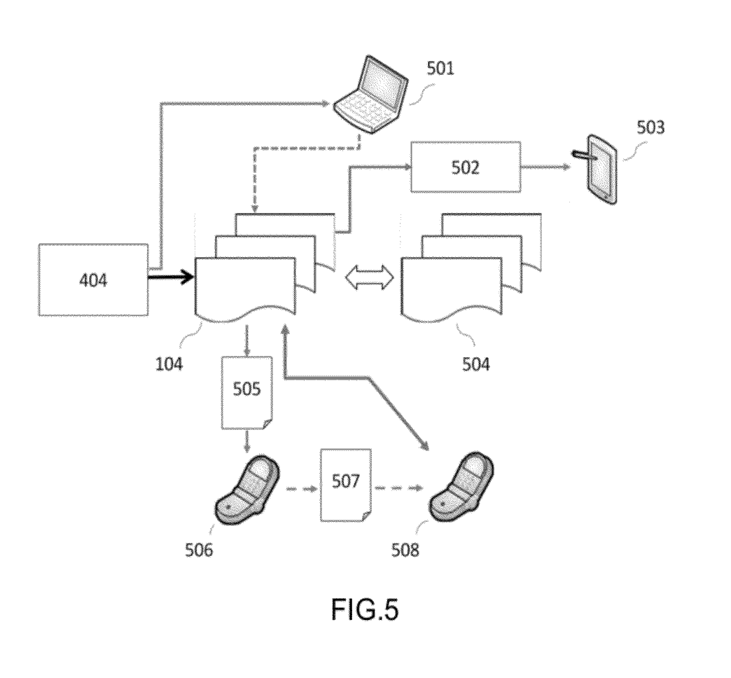

Referring to FIG. 5, the present invention may be realized through the emerging “clouding” environment instead of the physical infrastructure. In another embodiment of the present invention, all the data and program codes may be stored in the cloud by using any of cloud computing technologies, such as IaaS, PaaS, SaaS or any combination thereof. Alternatively, the transaction page 104 such generated may be incorporated as a part of a social networking service, which may function as MicroBlog, so that the social networking service is used as a platform that provides a user interface for accessing and operating the system of the present invention. In addition, for making each said transaction page as a potable medium, the transaction page may be inlaid to an existing SNS (Social Networking Services) website 504 or a portal website through a plug-in program, an RSS reader, an Atom reader or an XML protocol application. In this case, the transaction page 104 can be disseminated more widely in virtue of the extensive audience base and reputation of such website. Additionally, with the increasing subscription to SNS websites, a modern messaging program or browser, like one denoted as 501 in FIG. 5, is made to be capable of managing a person's more accounts registered in different SNS websites. Thereby, one can conveniently access data and manage his/her accounts through the messaging program preloaded in a personal computer or a mobile device, allowing his/her easy participation in the chain transactions. Also, the population of smart handsets has brought about increasing development of mobile applications such as iOS, Android OS, Symbian OS, webOS and Windows Phone OS. Such mobile application 502 can be downloaded to a mobile terminal 503 for running the transaction page 104. In one embodiment, the dissemination managing unit 404 may generate a transaction program 505 as an object those transaction information is followed. A user may load it in a mobile terminal 506, and send it to a mobile terminal 508 belonging to another user whose transactions are to be followed, thereby allowing a transaction program 507 to be built in both mobile terminals 506 and 508. When the mobile terminals 506 and 508 are on line, the transaction information can be used to update the transaction page 104, incurring more transactions. In another embodiment of the present invention, one can use the functions of automatic comment generation and dissemination to promote chain greeting in a social networking website through a bound commercial mode that promotes virtual or physical gifts. In still another embodiment, the present invention facilitates assembly of members of a social network and in turn facilitates chain response by allowing the audience to click on a reply button related to a certain activity for generating a personalized comment about the activity. In this fashion, statistic and analytic results of the comments about a certain activity can be easily obtained. In yet another embodiment, when interested in the dissemination, a user can trigger a button of subscription or interaction to reply to the dissemination in the manner similar to providing the automatically generated comments as described above. Moreover, different buttons may be provided to trigger comment scripts for improving personalized comments or responses. Then the automatic dissemination may be again performed to share the comments or responses to the audience, thus achieving interactive, viral advertising. Such dissemination can be incorporated to the reward system to encourage chain dissemination. For different commodities, the comment may be provided in different forms, such as and not limited to a user diary, a user feedback, an open-box report, a blog post, an experience sharing, a user reference and any combination thereof, as long as it is accretive to the audience and helpful to induce sequent transactions.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for prompting chain transactions, the method comprising receiving a merchandise information about a commodity from a database, and defining a part of a profit generated in a transaction of the commodity as a reward for a consumer who makes the transaction and performs dissemination of the transaction, whereby an incentive mechanism is built for promoting more sequent transactions, wherein completion of each said transaction results in generation of a unique transaction serial number and a corresponding transaction page that jointly function as a node for determining the reward and for recognizing the dissemination, in which the transaction page is associated with at least one social network where the dissemination is performed, thereby realizing a coadjutant consumption environment.

2. The method of claim 1, wherein the incentive mechanism allows setting parameters including different amounts of the rewards for the nodes of different tiers, a number of the tiers backward traceable to be rewarded, a proportion of the reward with respect to the profit, and a limited number of said sequent transactions allowable to be made rewarded through each said transaction serial number or each said node, in which each combination of the parameters of different settings is defined as a rewarding model.

3. The method of claim 1, wherein the transaction page is associated with said social network by adopting an API (Application Programming Interface) of a medium of the social network so as to share information with the social network.

4. The method of claim 1, wherein the transaction page is associated with said social network by making a webpage of the social network assessable from the transaction page through a plug-in program, an RSS reader, an Atom reader or an XML protocol application.

5. The method of claim 1, wherein the transaction page is associated with said social network by making an instant messenger related to said social network assessable from the transaction page through a plug-in program, an RSS reader, an Atom reader or an XML protocol application.

6. The method of claim 1, wherein the transaction page is associated with said social network by accessing information from the social network through a plurality of programs that allow the information to be loaded in a smart phone, an e-book reader or a mobile electronic device.

7. The method of claim 1, wherein only a limited number of said sequent transactions are allowed to be made through each said transaction serial number or each said node, so that when the number is reached, the incentive mechanism uses another said transaction serial number or another said node to complete further sequent transactions.

8. A computer executable program for facilitating dissemination that prompts chain transactions, the computer-executable program serving to: when a transaction button is triggered by a consumer to complete a transaction of a commodity, automatically compare a merchandise information of the commodity to recommendation comment keywords, personal comment keywords set by the consumer and past comment records, and accordingly generate options of recommended comments about the commodity for the consumer to adopt, so that the consumer is allowed to use any of the automatically generated recommended comments or revise any of the automatically generated recommended comments before use, and upon the consumer's decision of the comment(s), the merchandise information, the merchandise information, a transaction and the comment(s) are automatically posted on an associated website or sent to a preset group of audience, thereby facilitating dissemination.

9. The computer executable program of claim 8, further serving to facilitate chain dissemination by allowing the audience interested in the dissemination to click on a response button for generating a personalized comment about the commodity.

10. The computer executable program of claim 8, further serving to promote chain greeting in a social network by allowing the audience to click on a greeting button for generating a personalized greeting message.

11. The computer executable program of claim 8, further serving to facilitate assembly of members of a social network and in turn facilitate chain response by allowing the audience to click on a reply button related to a certain activity for generating a personalized comment about the activity.

12. The computer executable program of claim 8, wherein the comment has a format selected from the group consisting of a user diary a user feedback, an open-box report, a blog post, an experience sharing, a user reference and any combination thereof.

13. The computer executable program of claim 8, wherein the past comment records is extracted from comment keyword database where the past comments of all the consumers and about all the commodities are collected and classified according to consumer groups, merchandise groups and frequencies of use.

14. A system for prompting chain transactions, the system comprising: a server for storing the system and a database for storing data about commodities, merchandise details, rewarding models, an incentive mechanism, consumers, transactions, dissemination targets, rewarding information and rewarding records, whereby upon completion of a transaction where a transaction page is generated by the incentive mechanism, when a consumer triggers a transaction button on the transaction page, an automatic personalized-comment generating mechanism is actuated so that the system disseminates the consumer's comment(s) together with information abstracted, from the transaction page to the dissemination targets.

15. The system of claim 14, wherein the server is realized by a system incorporating SaaS (Software as a Service), PaaS (Platform as a Service) and/or other cloud-based technologies.

16. The system of claim 14, wherein the transaction page is provided as a webpage of a social network, in which each said consumer is allotted with an exclusive webpage where records of the consumer's transactions are provided.

17. The system of claim 14, wherein the transaction page appears in a webpage of a social network as a function module by adopting an API (Application Programming Interface) of a medium of the social network.

18. The system of claim 14, further including a credit rating mechanism, wherein the consumers who perform transactions as parties following each other are rewarded with points in their respective credit ratings, and cancellation of any said transaction results in taking the rewarded points off.

19. The system of claim 14, wherein the dissemination targets include a personal mobile device that accesses digital contents issued by the system through a preloaded application.

20. The system of claim 14, wherein the chain transactions includes transactions of physical merchandise, virtual merchandise, virtual currency, digital contents, services, commercial donation and/or non-commercial donation.
